(19) United States
(12) Patent Application Publication
(10) Pub. No.: US 2012/0006570 A1
(43) Pub. Date: Jan. 12, 2012

(54) FOAM NOZZLE EXPANSION TUBE

(75) Inventors: Todd B. Lozier, Elkhart, IN (US); James Robert Sutton, II, Union, MI (US)

(73) Assignee: ELKHART BRASS MANUFACTURING COMPANY, INC., Elkhart, IN (US)

(21) Appl. No.: 12/986,591

(22) Filed: Jan. 7, 2011

Related U.S. Application Data
(60) Provisional application No. 61/293,010, filed on Jan. 7, 2010.

(51) Int. Cl. A62C 31/22

(52) U.S. Cl. 169/70

(57) ABSTRACT

A foam expansion tube for a fire fighting nozzle includes a tubular body with a longitudinal axis and a passageway extending there through along the longitudinal axis for directing a foam and water mixture from a fire fighting nozzle. The passageway has a larger diameter than the outlet of the nozzle to provide an expansion tube for the foam/water mixture. The tubular body further includes an inlet end and an outlet end, with the inlet end having an inlet adapted for mounting to the outlet of the fire fighting nozzle for receiving the foam/water mixture into the passageway and having at least one opening to allow air to be drawn into the passageway for mixing with the foam/water mixture flowing through the passageway. The tube further includes a structure that extends into the passageway wherein the structure separates the foam/water mixture to further enhance the expansion of the foam and water mixture.

### CROSS-REFERENCE TO RELATED APPLICATIONS

This application claims priority and the benefit of provisional application entitled FOAM NOZZLE EXPANSION TUBE, Ser. No. 61/293,010, filed Jan. 7, 2010, which is incorporated herein by reference in its entirety.

### TECHNICAL FIELD AND BACKGROUND OF THE INVENTION

The present invention relates to an accessory for a nozzle and, more particularly, to a foam expansion tube for a fire fighting nozzle.

In the US, most foam solutions are AFFF (Aqueous Film Forming Foam). These are synthetic foams that once expanded or bubble up, will spread quickly due to their light structure and create a thin water or aqueous layer below the bubble structure, which will help cool the surface as it smothers the fire. AFFF is particularly useful on liquid hydrocarbon fires.

When used in fire fighting applications, foam is mixed with water as it flows through a nozzle. As the foam and water flow through the nozzle, the foam expands and gets “fluffed” up. To enhance the expansion of the foam, an expansion tube with a larger inner diameter than the nozzle's outlet can be mounted at the nozzle outlet. To introduce air into the foam/water mixture, the tube includes openings at the inlet end of the tube adjacent the outlet of the nozzle, with the flow of the foam/water mixture into the tube creating a venturi effect at the inlet end of the tube which draws air into the foam/water mixture through the openings at the inlet end of the tube.

To further enhance the expansion, expansion tubes have incorporated screens that are mounted in the tube and extend across the tube's flow passage. However, it has been found that the screens create significant drag on the foam mixture so that the reach of the foam mixture is limited. In applications where reach is important, the screens may not be suitable.

Another popular alternative to AFFF, predominantly outside of the US, is a FFFP (Film Forming Fluoroprotein) foam. This is not commonly used in the US because of the protein based surfactant and the issues it can cause in waterways, etc. A couple of advantages of FFFP, however, are that it is denser (a strong holding foam blanket) and resists breakdown by heat. However, it is also a thicker, more difficult to aspirate and requires greater agitation to fluff up and, therefore, typically require the use of the screens, which can limit their application.

Accordingly, there is a need for a device that can expand foam/water mixtures, including the mixtures with the denser FFFP foams, and better aspirate the foam without causing as much drag that is associated with the use of screens.

### SUMMARY OF THE INVENTION

Accordingly, the present invention provides an expansion tube that can expand foam/water mixture and aspirate the foam/water mixture without significantly impacting the reach of the nozzle.

In one form of the invention, a foam expansion tube for a fire fighting nozzle includes a tubular body with an inlet end and an outlet end. The inlet end has an inlet adapted for mounting to the outlet of a fire fighting nozzle for receiving a foam/water mixture into the tube's passageway and at least one opening to allow air to be drawn into the passageway for mixing with the foam/water mixture flowing through said passageway. The tube further includes an elongated member extending into the tube's passageway, which member has a cantilevered distal end in the passageway, which extends into the flow of the foam/water mixture wherein the elongated member separates the foam/water mixture to further enhance the expansion of the foam/water mixture.

In one aspect, the elongated member may have a passageway extending through the member from the exterior of the expansion tube to the interior of the expansion tube, which is in fluid communication with the passageway of the tube. In this manner, the flow of the foam/water mixture creates a venturi in the passageway of the elongated member, which draws air into the foam/water mixture where the foam/water mixture is separated by the elongated member.

According to another aspect, the elongated member introduces air into the foam/water mixture where the elongated member separates the foam/water mixture. Further, the elongated member introduces air into the foam/water mixture after the foam/water mixture has expanded to the inner surface of the expansion tube.

In other aspects, the elongated member extends into the passageway of the expansion tube at a non-orthogonal angle. For example, the elongated member may extend in the downstream direction and may form an acute angle with respect to the inner surface of the expansion tube. Further, the elongated member may comprise a round, hollow tube. Alternately, the upstream facing side of the elongated member may be tapered to further reduce the drag on the foam/water mixture.

In yet other aspects, the expansion tube includes a plurality of elongated members, which are spaced around the circumference of the tube, with each extending inwardly into the passageway of the expansion tube.

In another form of the invention, a foam expansion tube for a fire fighting nozzle includes a tubular body with a longitudinal axis and a passageway extending there through for directing a foam/water mixture from a fire fighting nozzle. The passageway has a larger diameter than the outlet of the nozzle to thereby form an expansion area for the foam and water mixture. The tubular body further has an inlet end and an outlet end, with the inlet end having an inlet adapted for mounting to the outlet of the fire fighting nozzle for receiving the foam/water mixture into the passageway and having at least one opening spaced radially outward from said inlet to allow air to be drawn into the passageway for mixing with the foam/water mixture flowing through the passageway. The expansion tube also includes an elongated member that extends into the passageway of the expansion tube at a non-orthogonal angle relative to the longitudinal axis wherein the elongated member separates the foam/water mixture to further enhance the expansion of the foam/water mixture.

In one aspect, the elongated member is adapted to introduce air into the foam/water mixture. For example, the elongated member is adapted to introduce air into the foam/water mixture where the elongated member separates the foam/water mixture.

In any of the above expansion tubes, the tubes may be mounted at the outlet of a fire fighting nozzle.

According to yet another form of the invention, a method of expanding a foam/water mixture flowing from a fire fighting nozzle includes directing the flow of the foam/water mixture into an expansion tube, increasing the cross-section of the flow path in the expansion tube, and aspirating the foam/water mixture with air after it has expanded due to the increase in cross-section of the flow path.

In one aspect, the foam/water mixture is aspirated by creating bubbles in the foam/water mixture and flowing air into the bubbles. For example, the air is flowed into the bubbles by drawing air into the bubbles using a venturi effect.

Accordingly, the present invention provides an expansion tube that can expand foam/water mixtures and aspirate the foam without significantly impacting the reach of the nozzle.

Theses and other objects, advantages, purposes, and features of the invention will become more apparent from the study of the following description taken in conjunction with the drawings.

### DETAILED DESCRIPTION OF THE DRAWINGS

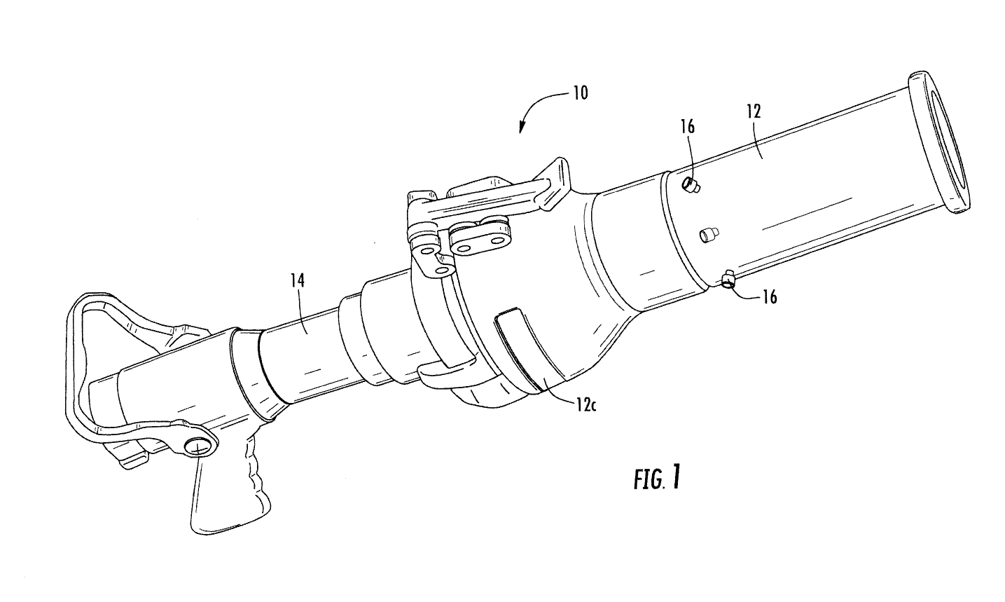

FIG. 1 is a perspective view of a nozzle incorporating one embodiment of a foam expansion tube of the present invention;

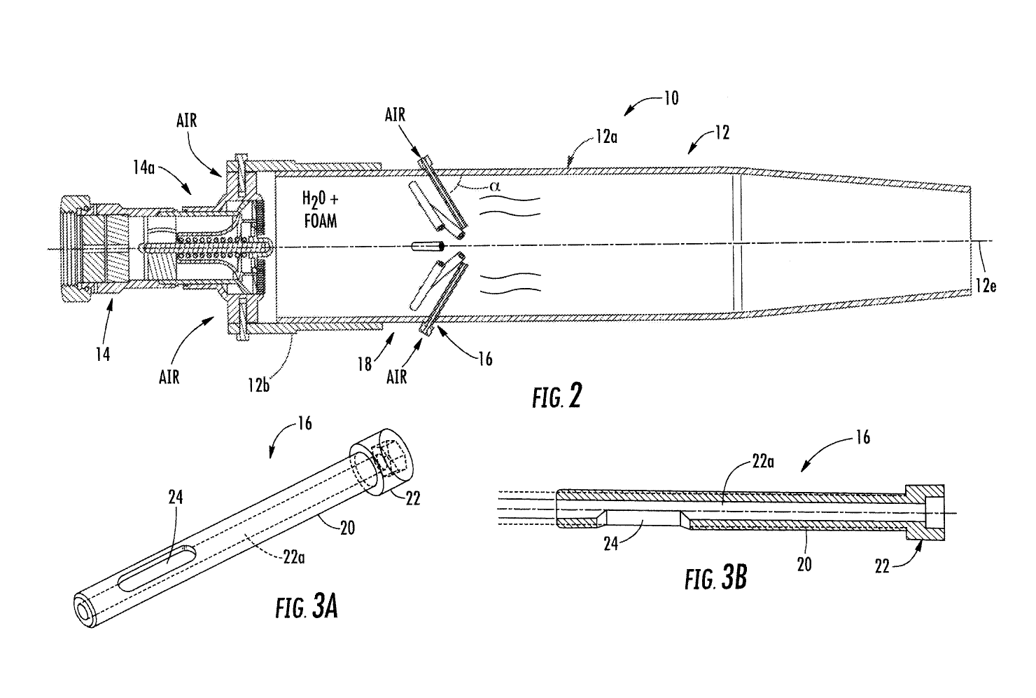

FIG. 2 is a cross-section view through the nozzle and tube of FIG. 1;

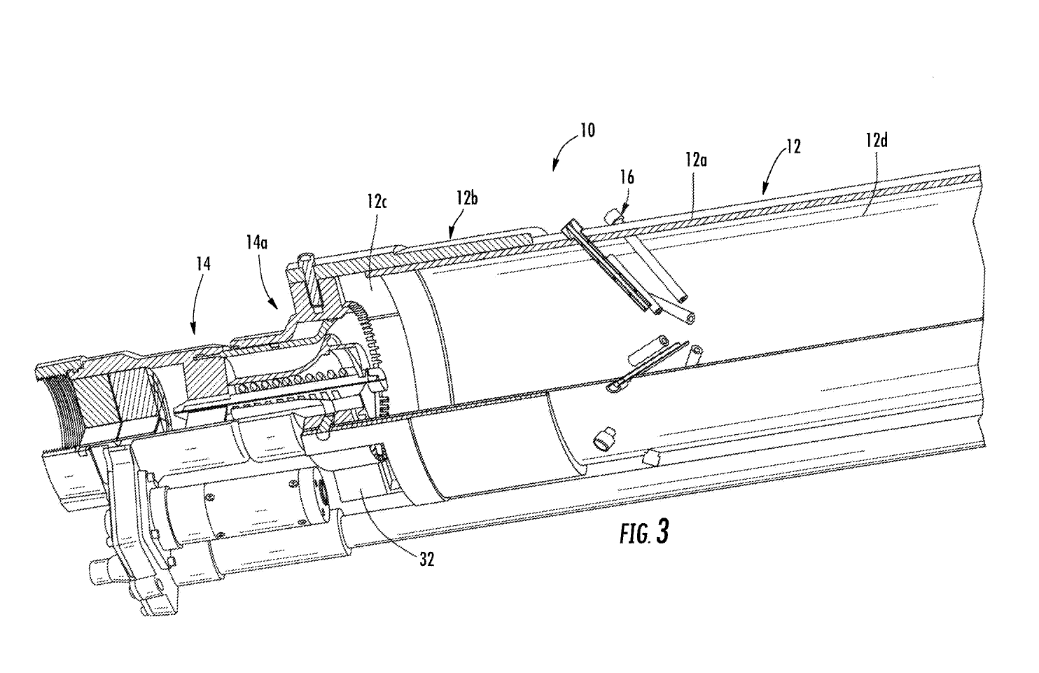

FIG. 3 is an enlarged partial fragmentary perspective cross-section of the nozzle and tube of FIG. 1;

FIG. 3A is an enlarged perspective view of a separating and aspirating structure incorporated into the expansion tube;

FIG. 3B is a cross-section of the separating and aspirating of FIG. 3A; and

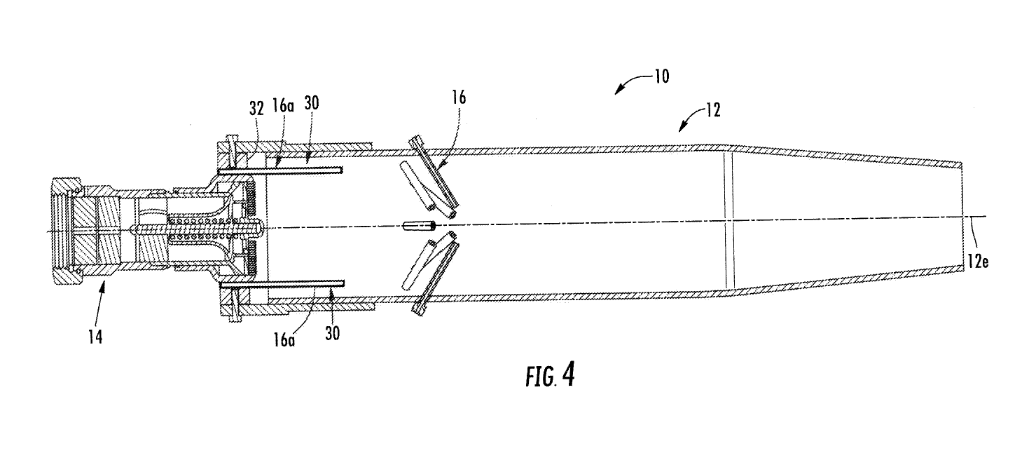

FIG. 4 is a similar view to FIG. 3 illustrating another embodiment of the foam expansion tube.

### DETAILED DESCRIPTION OF THE PREFERRED EMBODIMENTS

Referring to FIG. 1, the numeral 10 generally designates a nozzle assembly with a foam expansion tube 12 mounted to a nozzle body 14. Foam expansion tube 12 has a tubular body 12a that is mounted to the mile 14a of nozzle body 14 by a base 12b that includes one or more openings 12c to allow air to be drawn into the flow passageway 12d of expansion tube 12 by the venturi effect created by the foam/water mixture flowing into the tube 12. As will be more fully described below, foam expansion tube 12 is adapted to expand a foam/water mixture flowing through nozzle body 14 and into tube 12 and further optionally aspirate the foam/water mixture without significantly impacting the reach of the nozzle assembly.

As best seen in FIG. 2, passageway 12d has a greater diameter than the diameter of the outlet 14a of nozzle body 14. As such, the flow of foam/water mixture into tube 12 expands. It is this flow and expansion that creates the venturi effect adjacent the inlet end of the tube, noted above, that draws air into tube 12 through openings 12c. To further expand the foam/water mixture, tube 12 includes one or more structures 16 that project in to the flow of the foam/water mixture, which mechanically expand the foam by creating a disruption that stretches the foam as the foam/water mixture flows by to in effect create a bubble in the mixture. Optionally, to further enhance the expansion of the foam/water mixture, the structure is adapted to allow air to enter into the bubble (or bubbles) so that air is “inserted” into the bubble (or bubbles) thereby further increasing the expansion capability of the foam tube.

In the illustrated embodiment, tube 12 includes a plurality of structures 16, which are radially spaced around the circumference of tube 12 and located downstream of the initial expansion of the foam/water mixture into tube 12 where the foam/water mixture seals against the inside of passageway, which is indicated by the numeral 18. Further, structures 16 may extend into passageway 12d at a non-orthogonal angle with respect to the longitudinal axis 12e of tube 12 and further at an angle that is in the direction of the flow of the foam/water mixture so the structures 16 form an acute angle a with respect to the inner surface of tube 12 (FIG. 3).

Additionally, as illustrated, structures 16 may comprise elongated members in the form of round cylindrical hollow tubes 20 with enlarged heads 22. Each hollow tube 20 forms a passageway 22a that extends through tube 20 and enlarged head 22 so that it is in fluid communication with the ambient air outside expansion tube 12 and also is in fluid communication with passageway 12d. In the illustrated embodiment, hollow tube 20 includes an opening or perforation 24, such as a slotted opening, that extends through the sidewall of tube 20 into passageway 22a. Optionally, the tube may include a plurality of openings or perforations. As best seen in FIG. 2, openings 24 may face inwardly so that they are generally parallel to the flow of the incoming foam/water mixture so that when the mixture flows across the structures it passes by openings 24 and a venturi is created in the passageway, which draws air into the hollow tube and into the mixture. Further, as the mixture flows across tubes 20, the mixture stretches, which creates bubbles in the mixture. Thus, air is introduced into the mixture while the mixture is being stretched to fill and expand the bubbles created by the flow of the mixture across tubes 20. This introduction of air causes the mixture to further expand and to “fluff”. Thus, the holes in the tubes provide an added mechanism for air to “become inserted” into the bubble(s).

Further, as best seen in FIGS. 2 and 3, tubes 20 are supported in the sidewall of tube 12 and moreover supported such that their distal ends are cantilevered. In addition, as noted, the tubes 20 are angled so that their cantilevered ends are downstream from where they are supported and mounted to tube 12. In this manner, tubes 20 do not extend or traverse across the full width of the flow path. Thus, structures 16 do not produce the same drag as the prior art screens noted above.

As noted, in the illustrated embodiment structures 16 are round cylindrical tubes.

However, structures 16 may also be formed by solid or partially solid elongated members with tapered sides, such as blade shaped members, with the tapered sides facing the incoming foam/water mixture to further reduce the drag on the foam/water. The blade-shaped members may be similarly hollow with passageways extending there through so that they are also in fluid communication with the ambient air outside expansion tube 12 and in fluid communication with passageway 12d, for example, through openings provided in the sidewall of the blade-shaped members. Further, the structures may be formed at or by the side wall of the expansion tube. For example, apertures may be punched or otherwise formed in the side wall of the expansion tube with the displaced material projecting into the passageway to thereby form the structures.

Alternately, as illustrated in FIG. 4, additional structures 16a, for example, in the form of tubes 30 may be provided that extend into the inlet end of the expansion tube. Tubes 30 may be mounted at the outlet of nozzle 14, for example, radially outward of the nozzle outlet. Tubes 30 may be mounted to or in the expansion tube mount 32 (FIGS. 3 and 4) so that they extend into inlet end of expansion tube 12. Further, they may be oriented so that they are parallel to each other and to the longitudinal axis 12e of tube 12. They also may be hollow with their proximal ends open to the atmosphere outside the expansion tube and their distal end open to the passageway, with one or more openings or perforations formed in their side wall to form a venture effect in a similar manner as described in reference to tubes 20. They may also be angled to converge toward the central longitudinal axis 12e of tube 12 and additionally tapered at their distal ends.

Tubes 30 may also be used in place of tubes 20, i.e. tubes 20 may be omitted.

Additionally, tubes 30 may be used with or without the expansion tube. Without the expansion tube, air is introduced inside the water stream, which is in effect the reverse of how an expansion tube operates, which normally introduces air into the foam/water mixture from outside the water stream.

Thus the present invention provides an expansion mechanism that expands the foam/water mixture flowing into the tube from a fire fighting nozzle and further optionally aspirates the foam/water mixture with air after the foam/water mixture has initially expanded in the tube. As described, the foam/water mixture may be aspirated by separating the foam/water mixture, which creates bubbles, and flowing air into the bubbles by drawing air into the bubbles using a venturi effect. The drag on the foam/water mixture is reduced over prior art screens so that the present invention provides an expansion mechanism that can expand foam/water mixtures and aspirate the foam without significantly impacting the reach of the nozzle assembly.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

I claim:

1. A fire fighting nozzle comprising:
a nozzle body having an outlet;
a foam expansion tube, said foam expansion tube comprising a tubular body, the tubular body having a longitudinal axis and a passageway extending there through along the longitudinal axis for directing a foam and water mixture from the nozzle body, the passageway having a larger diameter than the outlet of the nozzle body to provide an expansion tube for the foam/water mixture, the tubular body further having an inlet end and an outlet end, the inlet end having an inlet adapted for mounting to the outlet of the fire fighting nozzle for receiving the foam/water mixture into the passageway and having at least one opening to allow air to be drawn into the passageway for mixing with the foam/water mixture flowing through the passageway; and
a structure in the passageway upstream from the outlet end of the tubular body and downstream from the inlet end, the structure extending into the flow of the foam/water mixture wherein the surface separates the foam/water mixture to further enhance the expansion of the foam and water mixture.

2. The fire fighting nozzle according to claim 1, further comprising an elongated member extending into the passageway forming the structure and having a cantilevered distal end, the distal end extending in and terminating in the passageway wherein the elongated member separates the foam/water mixture to further enhance the expansion of the foam and water mixture.

3. The fire fighting nozzle according to claim 2, wherein the elongated member includes a passageway extending there through and extending from the exterior of the expansion tube to the interior of the expansion tube, the passageway of the elongated member being in fluid communication with the passageway of the tube.

4. The fire fighting nozzle according to claim 2, wherein the elongated member is adapted to introduce air into the foam/water mixture where the elongated member separates the foam/water mixture.

5. The fire fighting nozzle according to claim 4, wherein the elongated member introduces air into the foam/water mixture at a location where the foam/water mixture has expanded to the inner surface of the expansion tube.

6. The fire fighting nozzle according to claim 2, the elongated member extends into the passageway of the expansion tube at a non-orthogonal angle.

7. The fire fighting nozzle according to claim 6, wherein the elongated member extends in the downstream direction of the flow of the foam/water mixture

8. The fire fighting nozzle according to claim 7, wherein the elongated member forms an acute angle with respect to the inner surface of the expansion tube.

9. The fire fighting nozzle according to claim 2, wherein the elongated member comprises a round, hollow tube.

10. The fire fighting nozzle according to claim 2, wherein the upstream facing side of the elongated member is tapered.

11. The fire fighting nozzle according to claim 2, wherein the expansion tube includes a plurality of said elongated member.

12. The fire fighting nozzle according to claim 11, wherein the elongated members are spaced around the circumference of the expansion tube, each elongated member extending inwardly into the passageway of the expansion tube.

13. A foam expansion tube for a fire fighting nozzle, the foam expansion tube comprising:
a tubular body, the tubular body having a longitudinal axis and a passageway extending there through along the longitudinal axis for directing a foam and water mixture from a fire fighting nozzle, the passageway having a larger diameter than the outlet of the nozzle to provide an expansion tube for the foam/water mixture, the tubular body further having an inlet end and an outlet end, the inlet end having an inlet adapted for mounting to the outlet of the fire fighting nozzle for receiving the foam/water mixture into the passageway and having at least one opening to allow air to be drawn into the passageway for mixing with the foam/water mixture flowing through the passageway; and
an elongated member extending into the passageway having a cantilevered distal end in the passageway wherein the elongated member separates the foam/water mixture to further enhance the expansion of the foam and water mixture.

14. The foam expansion tube according to claim 13, wherein the elongated member includes a passageway extending there through and extending from the exterior of the expansion tube to the interior of the expansion tube, the passageway of the elongated member being in fluid communication with the passageway of the tube.

15. The foam expansion tube according to claim 13, wherein the elongated member is adapted to introduce air into the foam/water mixture where the elongated member separates the foam/water mixture.

16. The foam expansion tube according to claim 13, wherein the elongated member introduces air into the foam/water mixture after the foam/water mixture has expanded to the inner surface of the expansion tube.

17. The foam expansion tube according to claim 13, the elongated member extends into the passageway of the expansion tube at a non-orthogonal angle.

18. The foam expansion tube according to claim 17, wherein the elongated member extends in the downstream direction of the flow of the foam/water mixture and forms an acute angle with respect to the inner surface of the expansion tube.

19. The foam expansion tube according to claim 13, wherein the elongated member comprises a round, hollow tube.

20. The foam expansion tube according to claim 13, wherein the expansion tube includes a plurality of the elongated member.

21. The foam expansion tube according to claim 20, wherein the elongated members are spaced around the circumference of the expansion tube, each elongated member extending inwardly into the passageway of the expansion tube.

22. A foam expansion tube for a fire fighting nozzle, said expansion tube comprising:
a tubular body having a longitudinal axis and a passageway extending there through for directing a foam/water mixture from a fire fighting nozzle, the passageway having an expansion area for the foam and water mixture, the tubular body further having an inlet end and an outlet end, with the inlet end having an inlet adapted for mounting to the outlet of the fire fighting nozzle for receiving the foam/water mixture into the passageway and having at least one opening down stream from the inlet to allow air to be drawn into the passageway for mixing with the foam/water mixture flowing through the passageway; and
a structure extending into the passageway of the expansion tube upstream of the outlet of the expansion tube wherein the elongated member separates the foam/water mixture to further enhance the expansion of the foam/water mixture.

23. The foam expansion tube according to claim 22, wherein the structure comprises an elongated member.

24. The foam expansion tube according to claim 23, wherein the elongated member is adapted to introduce air into the foam/water mixture.

25. A fire fighting nozzle comprising:
a nozzle body having an outlet about a central longitudinal axis;
an elongate member extending in a direction along said central longitudinal axis radially outward of said outlet to separate a foam/water mixture flowing through said nozzle body and from said outlet.

26. A method of expanding a foam/water mixture flowing from a fire fighting nozzle, said method comprising:
directing the flow of the foam/water mixture into an expansion tube;
increasing the cross-section of the flow path in the expansion tube; and
aspirating the foam/water mixture with air after it has expanded due to the increase in cross-section of the flow path.

27. The method according to claim 26, wherein the aspirating comprising creating bubbles in the foam/water mixture and flowing air into the bubbles.

28. The method according to claim 27, wherein the flowing comprises drawing air into the bubbles using a venturi effect.

29. The method according to claim 28, said aspirating the foam/water mixture with air after comprises aspirating the foam/water mixture with air at multiple locations.
